(19) United States
(12) Patent Application Publication
(10) Pub. No.: US 2009/0223317 A1
(43) Pub. Date: Sep. 10, 2009

(54) Gearshift Interlock

(75) Inventor: Graham M. Annear, South Lyon, MI (US)

Correspondence Address: WARN, HOFFMANN, MILLER & LALONE, .P.C, PO BOX 70098, ROCHESTER HILLS, MI, 48307, US

(73) Assignee: BORGWARNER INC., Auburn Hills, MI (US)

(21) Appl. No.: 12/225,612

(22) PCT Filed: Jun. 26, 2007
(86) PCT No.: PCT/US2007/014744

§ 371 Date: May 20, 2009

Related U.S. Application Data
(60) Provisional application No. 60/816,779, filed on Jun. 27, 2006.

(51) Int. Cl. G05G 5/08

(52) U.S. Cl. 74/473.24

(57) ABSTRACT

A gearshift interlock is provided including a first shift block operatively associated with a first synchronized gear. The first shift block is movable between neutral and actuated positions and has a detent. A second shift block is provided operatively associated with a second synchronized gear. The second shift block is movable between neutral and actuated positions and has a detent. A lockout member is provided wherein movement of one of the shift blocks from the neutral position toward the actuated position causes that shift block to urge the lockout member to engage the other shift block detent preventing movement of the other shift block.

### CROSS-REFERENCE TO RELATED APPLICATIONS

This application claims the benefit of U.S. Provisional Application No. 60/816,779, filed Jun. 27, 2006.

### FIELD OF THE INVENTION

The field of the present invention is that of gearshift interlocks and automotive transmissions which utilize gearshift interlocks.

### BACKGROUND OF THE INVENTION

Generally speaking, land vehicles require a powertrain consisting of three basic components. These components include power plant (such as an internal combustion engine), a power transmission, and wheels. The power transmission component is typically referred to simply as the “transmission.” Engine torque and speed are converted in the transmission in accordance with the tractive-power demand of the vehicle. Presently, there are two typical transmissions widely available for use in conventional motor vehicles. The first and oldest type is the manually operated transmission. These transmissions include a foot-operated start-up or launch clutch that engages and disengages the driveline with the power plant and a gearshift lever to selectively change the gear ratios within the transmission. When driving a vehicle having a manual transmission, the driver must coordinate the operation of the dutch pedal, the gearshift lever, and the accelerator pedal to achieve a smooth and efficient shift from one gear to the next. The structure of a manual transmission is simple and robust and provides good fuel economy by having a direct power connection from the engine to the final drive wheels of the vehicle. Additionally, since the operator is given complete control over the timing of the shifts, the operator is able to dynamically adjust the shifting process so that the vehicle can be driven most efficiently. One disadvantage of the manual transmission is that there is an interruption in the drive connection during gear shifting. This results in losses in efficiency. In addition, there is a great deal of physical interaction required on the part of the operator to shift gears in a vehicle that employs a manual transmission.

The second, and newer choice for the transmission of power in a conventional motor vehicle is an automatic transmission. Automatic transmissions offer ease of operation. The driver of a vehicle having an automatic transmission is not required to use both hands, one for the steering wheel and one for the gearshift, and both feet, one for the clutch and one for the accelerator and brake pedal in order to safely operate the vehicle. In addition, an automatic transmission provides greater convenience in stop and go situations, because the driver is not concerned about continuously shifting gears to adjust to the ever-changing speed of traffic. Although conventional automatic transmissions avoid an interruption in the drive connection during gear shifting, they suffer from the disadvantage of reduced efficiency because of the need for hydrokinetic devices, such as torque converters, interposed between the output of the engine and the input of the transmission for transferring kinetic energy therebetween. In addition, automatic transmissions are typically more mechanically complex and therefore more expensive than manual transmissions.

For example, torque converters typically include impeller assemblies that are operatively connected for rotation with the torque input from an internal combustion engine, a turbine assembly that is fluidly connected in driven relationship with the impeller assembly and a stator or reactor assembly. These assemblies together form a substantially toroidal flow passage for kinetic fluid in the torque converter. Each assembly includes a plurality of blades or vanes that act to convert mechanical energy to hydrokinetic energy and back to mechanical energy. The stator assembly of a conventional torque converter is locked against rotation in one direction but is free to spin about an axis in the direction of rotation of the impeller assembly and turbine assembly. When the stator assembly is locked against rotation, the torque is multiplied by the torque converter. During torque multiplication, the output torque is greater than the input torque for the torque converter. However, when there is no torque multiplication, the torque converter becomes a fluid coupling. Fluid couplings have inherent slip. Torque converter slip exists when the speed ratio is less than 1.0 (RPM input>than RPM output of the torque converter). The inherent slip reduces the efficiency of the torque converter.

While torque converters provide a smooth coupling between the engine and the transmission, the slippage of the torque converter results in a parasitic loss, thereby decreasing the efficiency of the entire powertrain. Further, the torque converter itself requires pressurized hydraulic fluid in addition to any pressurized fluid requirements for the actuation of the gear shifting operations. This means that an automatic transmission must have a large capacity pump to provide the necessary hydraulic pressure for both converter engagement and shift changes. The power required to drive the pump and pressurize the fluid introduces additional parasitic losses of efficiency in the automatic transmission.

In an ongoing attempt to provide a vehicle transmission that has the advantages of both types of transmissions with fewer of the drawbacks, combinations of the traditional “manual” and “automatic” transmissions have evolved. Most recently, “automated” variants of conventional manual transmissions have been developed which shift automatically without any input from the vehicle operator. Such automated manual transmissions typically include a plurality of power-operated actuators that are controlled by a transmission controller or some type of electronic control unit (ECU) to automatically shift synchronized clutches that control the engagement of meshed gear wheels traditionally found in manual transmissions. The design variants have included either electrically or hydraulically powered actuators to affect the gear changes. However, even with the inherent improvements of these newer automated transmissions, they still have the disadvantage of a power interruption in the drive connection between the input shaft and the output shaft during sequential gear shifting. Power interrupted shifting results in a harsh shift feel that is generally considered to be unacceptable when compared to smooth shift feel associated with most conventional automatic transmissions.

To overcome this problem, other automated manual type transmissions have been developed that can be power-shifted to permit gearshifts to be made under load. Examples of such power-shifted automated manual transmissions are shown in U.S. Pat. No. 5,711,409 issued on Jan. 27, 1998 to Murata for a Twin-Clutch Type Transmission, and U.S. Pat. No. 5,966,989 issued on Apr. 4, 2000 to Reed, Jr. et al for an Electro-mechanical Automatic Transmission having Dual Input Shafts. These particular types of automated manual transmissions have two clutches and are generally referred to simply as dual, or twin, clutch transmissions. The dual clutch structure is most often coaxially and cooperatively configured so as to derive power input from a single engine flywheel arrangement. However, some designs have a dual clutch assembly that is coaxial but with the clutches located on opposite sides of the transmission's body and having different input sources. Regardless, the layout is the equivalent of having two transmissions in one housing, namely one power transmission assembly on each of two input shafts concomitantly driving one output shaft. Each transmission can be shifted and clutched independently. In this manner, uninterrupted power upshifting and downshifting between gears, along with the high mechanical efficiency of a manual transmission is available in an automatic transmission form. Thus, significant increases in fuel economy and vehicle performance may be achieved through the effective use of certain automated manual transmissions.

The dual clutch transmission structure may include two dry disc clutches each with their own clutch actuator to control the engagement and disengagement of the two-clutch discs independently. While the clutch actuators may be of the electromechanical type, since a lubrication system within the transmission requires a pump, some dual clutch transmissions utilize hydraulic shifting and clutch control. These pumps are most often gerotor types, and are much smaller than those used in conventional automatic transmissions because they typically do not have to supply a torque converter. Thus, any parasitic losses are kept small. Shifts are accomplished by engaging the desired gear prior to a shift event and subsequently engaging the corresponding clutch. With two clutches and two inputs shafts, at certain times, the dual clutch transmission may be in two different gear ratios at once, but only one clutch will be engaged and transmitting power at any given moment. To shift to the next higher gear, first the desired gears on the input shaft of the non-driven clutch assembly are engaged, then the driven clutch is released and the non-driven clutch is engaged.

This requires that the dual clutch transmission be configured to have the forward gear ratios alternatingly arranged on their respective input shafts. In other words, to perform up-shifts from first to second gear, the first and second gears must be on different input shafts. Therefore, the odd gears will be associated with one input shaft and the even gears will be associated with the other input shaft. In view of this convention, the input shafts are generally referred to as the odd and even shafts. Typically, the input shafts transfer the applied torque to a single counter shaft, which includes mating gears to the input shaft gears. The mating gears of the counter shaft are in constant mesh with the gears on the input shafts. The counter shaft also includes an output gear that is meshingly engaged to a gear on the output shaft. Thus, the input torque from the engine is transferred from one of the clutches to an input shaft, through a gear set to the counter shaft and from the counter shaft to the output shaft.

Gear engagement in a dual clutch transmission is similar to that in a conventional manual transmission. One of the gears in each of the gear sets is disposed on its respective shaft in such a manner so that it can freewheel about the shaft. A synchronizer is also disposed on the shaft next to the freewheeling gear so that the synchronizer can selectively engage the gear to the shaft. To automate the transmission, the mechanical selection of each of the gear sets is typically performed by some type of actuator that moves the synchronizers. A reverse gear set includes a gear on one of the input shafts, a gear on the counter shaft, and an intermediate gear mounted on a separate counter shaft meshingly disposed between the two so that reverse movement of the output shaft may be achieved.

In the above noted transmission, synchronizer mechanisms for the 1-3 gear combination, 2-R gear combination and 4-6 gear combination are often associated with one another. It is desirable to provide an interlock for the synchronizer mechanisms to prevent simultaneous engagement of associated gears.

### SUMMARY OF THE INVENTION

To meet the aforementioned and other manifold desires, a revelation of the present invention is brought forth. In a preferred embodiment, the present invention provides a gearshift interlock including a first shift block operatively associated with a first synchronized gear. The first shift block is movable between neutral and actuated positions and has a detent. A second shift block is provided operatively associated with a second synchronized gear. The second shift block is movable between neutral and actuated positions and has a detent. A lockout member is provided wherein movement of one of the shift blocks from the neutral position toward the actuated position causes that shift block to urge the lockout member to engage the other shift block detent preventing movement of the other shift block.

Other features of the invention will become more apparent to those skilled in the art as the invention is further revealed in the accompanying drawings and detailed description of the invention.

### BRIEF DESCRIPTION OF THE DRAWINGS

FIG. 1 is a schematic view of an inventive preferred embodiment dual clutch transmission utilizing a gearshift interlock of the present invention.

FIG. 2 is a partial perspective view of a shift fork connection with a shift block of a gearshift interlock of the present invention.

FIG. 3 is a side schematic view of a gearshift interlock of the present invention.

FIGS. 4A-4C are schematic front views illustrating operation of the gearshift interlock shown in FIG. 2.

FIGS. 5A-5C are schematic top views illustrating operation of the gearshift interlock shown in FIG. 2.

FIGS. 6-10 are views similar to FIG. 4B of alternate preferred embodiments gearshift interlocks of the present invention.

FIGS. 11 and 11A are front and side elevation views of a shift fork shown in FIG. 2.

### DETAILED DESCRIPTION OF THE INVENTION

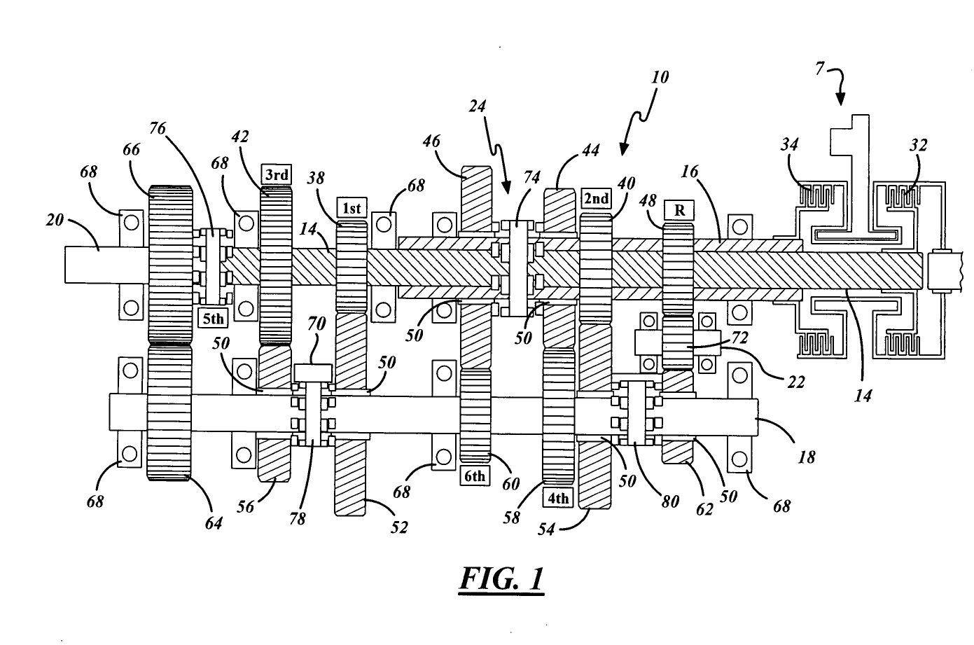

A representative dual clutch transmission that may be used with a gearshift interlock of the present invention is generally indicated at 10 in the schematic illustrated in FIG. 1. Specifically, as shown in FIG. 1, the dual clutch transmission 10 includes a dual, coaxial clutch arrangement including clutch mechanisms 32 and 34, a first input shaft, generally indicated at 14, a second input shaft, generally indicated at 16, that is coaxial to the first, a counter shaft, generally indicated at 18, an output shaft 20, a reverse counter shaft 22, a plurality of synchronizers, generally indicated at 24, and a plurality of shift actuators generally (not shown).

The dual clutch transmission 10 forms a portion of a vehicle powertrain and is responsible for taking a torque input from a prime mover, such as an internal combustion engine, and transmitting the torque through selectable gear ratios to the vehicle drive wheels. The dual clutch transmission 10 operatively routes the applied torque from the engine through the dual, coaxial clutch arrangement 7 to either the first input shaft 14 or the second input shaft 16. The input shafts 14 and 16 include a first series of gears, which are in constant mesh with a second series of gears disposed on the counter shaft 18. Each one of the first series of gears interacts with one of the second series of gears to provide the different gear ratio sets used for transferring torque. The counter shaft 18 also includes a first output gear that is in constant mesh with a second output gear disposed on the output shaft 20. The plurality of synchronizers 24 are disposed on the two input shafts 14, 16 and on the counter shaft 18 and are operatively controlled by the plurality of shift actuators to selectively engage one of the gear ratio sets. Thus, torque is transferred from the engine to the dual, coaxial clutch arrangement 7, to one of the input shafts 14 or 16, to the counter shaft 18 through one of the gear ratio sets, and to the output shaft 20. The output shaft 20 further provides the output torque to the remainder of the powertrain. Additionally, the reverse counter shaft 22 includes an intermediate gear that is disposed between one of the first series of gears and one of the second series of gears, which allows for a reverse rotation of the counter shaft 18 and the output shaft 20. Each of these components will be discussed in greater detail below.

Specifically, the dual, coaxial clutch arrangement 7 includes a first clutch mechanism 32 and a second clutch mechanism 34. The first clutch mechanism 32 is, in part, physically connected to a portion of the engine flywheel (not shown) and is, in part, physically attached to the first input shaft 14, such that the first clutch mechanism 32 can operatively and selectively engage or disengage the first input shaft 14 to and from the flywheel. Similarly, the second clutch mechanism 34 is, in part, physically connected to a portion of the flywheel and is, in part, physically attached to the second input shaft 16, such that the second clutch mechanism 34 can operatively and selectively engage or disengage the second input shaft 16 to and from the flywheel. As can be seen from FIG. 1, the first and second clutch mechanisms 32, 34 are coaxial and axially spaced from one another such that the clutch housing of the first clutch mechanism 32 is in front of the clutch housing of the second clutch mechanism 34. The first and second input shafts 14, 16 are also coaxial and co-centric such that the second input shaft 16 is hollow having an inside diameter sufficient to allow the first input shaft 14 to pass through and be partially supported by the second input shaft 16. The first input shaft 14 includes a first input gear 38 and a third input gear 42. The first input shaft 14 is longer in length than the second input shaft 16 so that the first input gear 38 and a third input gear 42 are disposed on the portion of the first input shaft 14 that extends beyond the second input shaft 16. The second input shaft 16 includes a second input gear 40, a fourth input gear 44, a sixth input gear 46, and a reverse input gear 48. As shown in FIG. 1, the second input gear 40 and the reverse input gear 48 are fixedly supported on the second input shaft 16 and the fourth input gear 44 and sixth input gear 46 are rotatably supported about the second input shaft 16 upon bearing assemblies 50 so that their rotation is unrestrained unless the accompanying synchronizer is engaged, as will be discussed in greater detail below.

The counter shaft 18 is a single, one-piece shaft that includes the opposing, or counter, gears to those on the inputs shafts 14, 16. As shown in FIG. 1, the counter shaft 18 includes a first counter gear 52, a second counter gear 54, a third counter gear 56, a fourth counter gear 58, a sixth counter gear 60, and a reverse counter gear 62. The counter shaft 18 fixedly retains the fourth counter gear 58 and sixth counter gear 60, while first, second, third, and reverse counter gears 52, 54, 56, 62 are supported about the counter shaft 18 by bearing assemblies 50 so that their rotation is unrestrained unless the accompanying synchronizer is engaged as will be discussed in greater detail below. The counter shaft 18 also fixedly retains a first drive gear 64 that meshingly engages the corresponding second driven gear 66 on the output shaft 20. The second driven gear 66 is fixedly mounted on the output shaft 20. The output shaft 20 extends outward from the transmission 10 to provide an attachment for the remainder of the powertrain.

The reverse counter shaft 22 is a relatively short shaft having a single reverse intermediate gear 72 that is disposed between, and meshingly engaged with, the reverse input gear 48 on the second input shaft 16 and the reverse counter gear 62 on the counter shaft 18. Thus, when the reverse gears 48, 62, and 72 are engaged, the reverse intermediate gear 72 on the reverse counter shaft 22 causes the counter shaft 18 to turn in the opposite rotational direction from the forward gears thereby providing a reverse rotation of the output shaft 20. It should be appreciated that all of the shafts of the dual clutch transmission 10 are disposed and rotationally secured within the transmission 10 by some manner of bearing assembly such as roller bearings, for example, shown at 68 in FIG. 1.

The engagement and disengagement of the various forward and reverse gears is accomplished by the actuation of the synchronizers 24 within the transmission. As shown in FIG. 1 in this example of a dual clutch transmission 10, there are four synchronizers 74, 76, 78, and 80 utilized to shift through the six forward gears and reverse. It should be appreciated that there are a variety of known types of synchronizers that are capable of engaging a gear to a shaft and that the particular type employed for the purposes of this discussion is beyond the scope of the present invention. Generally speaking, any type of synchronizer that is movable by a shift fork or like device may be employed. As shown in the representative example of FIG. 1, the synchronizers (with the exception of synchronizer 76) are dual actuated synchronizers, such that they selectively engage one of two separate gears to the same respective shaft. Specifically with reference to the example illustrated in FIG. 1, synchronizer 78 can engage the first counter gear 52 on the counter shaft 18 or engage the third counter gear 56. Synchronizer 80 can engage the reverse counter gear 62 or engage the second counter gear 54. Likewise, synchronizer 74 can engage the fourth input gear 44 or engage the sixth input gear 46. Single acting synchronizer 76 can selectively connect the end of the first input shaft 14 to the output shaft 20 thereby providing a direct 1:1 (one to one) drive ratio for fifth gear. It should be appreciated that this example of the dual clutch transmission is representative and that other gear set, synchronizer, and shift actuator arrangements are possible within the dual clutch transmission 10 as long as the even and odd gear sets are disposed on opposite input shafts.

To actuate the synchronizers 74, 76, 78, and 80, this representative example of a dual clutch transmission 10 utilizes hydraulically driven shift actuators with attached shift forks. The dual actuated synchronizers 78, 74 and 80 all incorporate a gearshift interlock 70 (only the gearshift interlock for the synchronizer 78 is shown for clarity of illustration) of the present invention to prevent inadvertent simultaneous multiple gear engagement.

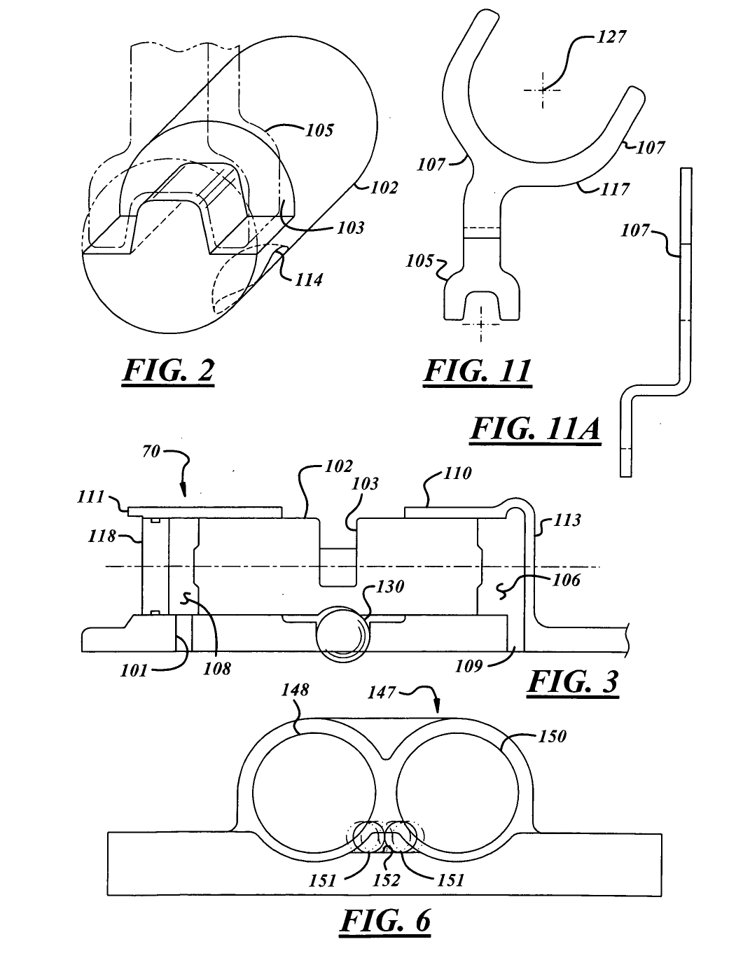

Referring to FIGS. 2-5C, 11, and 11A the gearshift interlock 70 arrangement of the present invention includes a first shift block 102. The first shift block 102 is operatively associated with a first synchronized gear 56. The first shift block 102 has a cut out 103 formed to accept a foot 105 of a shift fork 107.

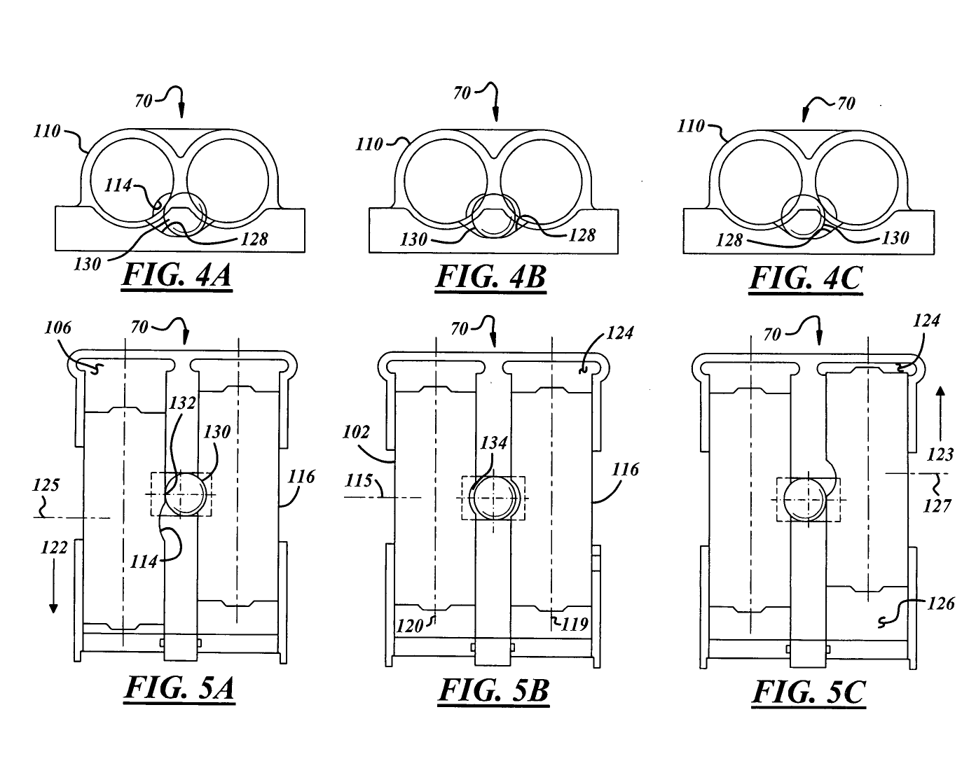

The shift block 102 is linearly slideably mounted in a housing 110 having a closed end 113 and an open end 111. Adjacent the open end 111 is a blind flange 118. The first shift block 102 is sealed within a first control volume 106 along a first extreme end, and a second control volume 108 along a second extreme end. The first shift block 102 has a neutral position 115 as shown in FIGS. 4B and 5B. To hydraulically move the shift block 102 to a fully actuated position 125, the control volume 106 is pressurized (via an inlet/outlet line 109) and or the controlled volume 108 is depressurized (via an inlet/outlet line 101). The shift block 102 will move in a direction of arrow 122 to the position 125. To return the shift block 102 to the neutral position 115, the control volume 108 is pressurized and or the control volume 106 is depressurized.

The shift block 102 has an integrally formed conical detent 114. The detent 114 faces a generally adjacent second shift block 116. The second shift block 116 is operatively associated with a second synchronized gear 52 (via a shift fork, not shown) that is a mirror image of the shift fork 107. The shift forks have axially and laterally offset collars 117 allowing a centerline 127 of the collars to be axially aligned with each other. The second shift block 116 is typically a mirror image the first shift block 102 and as shown in FIGS. 4B and 5B shares a common neutral position 115. The second shift block 116 is hydraulically moved along a path 119 that is parallel to a path 120 of travel for the first shift block 102. Actuation of the second shift block 116 causes the second shift block 116 to move in a direction of arrow 123 opposite of that of arrow 122 to a position 123. The second shift block 116 is sealed along its extreme ends in control volumes 124 and 126.

Positioned between the shift blocks 102 and 116 in a concave seat 128 is a spherical lockout member or ball 130. When the shift blocks 102 and 116 are in the neutral positions as shown in FIGS. 4B and 5B the lockout ball 130 is positioned generally within both of the detents 114 (with a slight amount of clearance 134 with both detects 114). When the shift block 102 is moved in the direction of arrow 122 during activation, a ride out surface 132 of the shift block 102 urges the lockout ball 130 fully into the detent 114 of the second shift block 116. With the lockout member 130 fully engaged within the detent 114 of the second shift block 116, the second shift block 116 is locked out from movement (FIGS. 4A and 5A). Consequently, the gear 52 associated with the second shift block 116 cannot be engaged. When the first shift block 102 is returned to its neutral position 115 shown in FIGS. 4B and 5B, the locking ball slight clearance 134 with the detents 114 is restored. From the neutral position 115 the second shift block 116 and its associated gear can be engaged causing the lockout ball to 130 fully engage with the detent 114 of the first shift block 102 and the first block 102 and its associated gear is blocked from engagement (FIGS. 4C and 5C).

Referring to FIG. 6, an alternate preferred embodiment of gearshift interlock 147 is shown. The shift blocks 148 and 150 are almost identical to those of aforedescribed. Spherical balls 151 provide a multiple-piece lockout member. The lockout balls 151 are positioned in a generally flat seat 152.

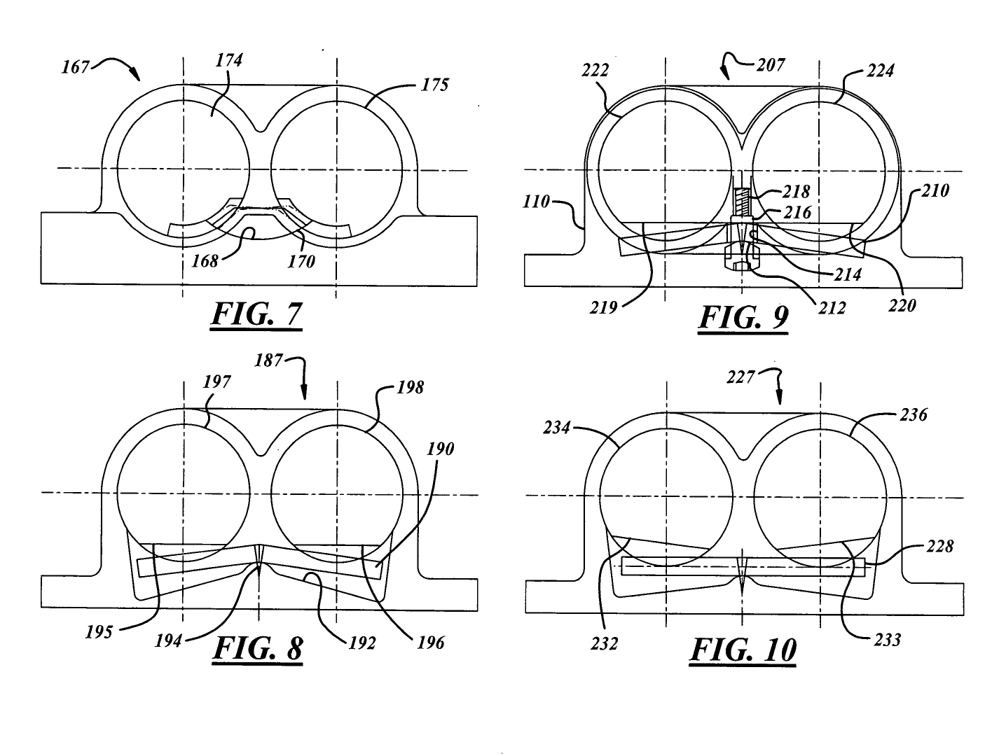

Referring to FIG. 7, an alternate preferred embodiment gearshift interlock 167 is provided having a generally concave seat 168 and arcuate lockout member 170. Instead of the translational movement of the lockout ball, lockout member 170 is urged into arcuate movement upon activation of one of the shift blocks 174, 175.

Referring to FIG. 8, an alternate embodiment gearshift interlock 187 is provided having convex bent elongated pendulum lockout member 190. The pendulum 190 is positioned on a concave seat 192 and pivots about a pivot point 194. The detent faces 195 and 196 of shift blocks 197 and 198 are parallel facing instead of the cross facing as with the detents 114 of FIGS. 4A-5C.

Referring to FIG. 9 an alternate embodiment gearshift interlock 207 is provided with a bent elongated lockout member pendulum 210 and a pivot point 212. The pivot point 212 is connected with a stem 216 that extends through an aperture 214 in the pendulum 210. The stem 216 has a threaded portion 218 that is threaded within a bore of the housing 110. The pivot point 212 can be adjusted axially to insure that the pendulum properly engages with the detent faces 219 and 220 of the of the shift blocks 222 and 224.

Referring to FIG. 10, an alternate embodiment gearshift interlock 227 is provided. The gearshift interlock 227 has a straight pendulum 228. The gearshift interlock 227 has angled outward facing detent faces 232, 233 on shift blocks 234 and 236.

While preferred embodiments of the present invention have been disclosed, it is to be understood it has been described by way of example only, and various modifications can be made without departing from the spirit and scope of the invention as it is encompassed in the following claims.

What is claimed is:

1. A gearshift interlock comprising:
a first shift block operatively associated with a first synchronized gear, said first shift block being movable between neutral and actuated positions, said first shift block having detent;
a second shift block operatively associated with a second synchronized gear, said second shift block being movable between neutral and actuated positions, said second shift block having a detent; and
a lockout member wherein movement of one of said shift blocks from said neutral position toward said actuated position cause said shift block to urge said lockout member to engage said other shift block detent to prevent movement of said other shift block.

2. A gearshift interlock as described claim 1 wherein movement of said shift blocks is linear.

3. A gearshift interlock as described claim 1 wherein said shift blocks are hydraulically moved.

4. A gearshift interlock as described claim 1 wherein said shift blocks move on parallel paths.

5. A gearshift interlock as described claim 1 wherein said lockout member is spherical.

6. A gearshift interlock as described claim 1 wherein said lockout member is provided by a plurality of pieces.

7. A gearshift interlock as described in claim 1 wherein said lockout number is positioned in a generally concave seat.

8. A gearshift interlock as described claim 1 wherein said lockout member is a generally arcuate piece.

9. A gearshift interlock as described claim 1 wherein detent is conically shaped.

10. A gearshift interlock as described claim 1 wherein said lockout member is positioned in a generally convex seat.

11. A gearshift interlock as described claim 1 wherein said lockout member is a pendulum.

12. A gearshift interlock as described in claim 11 wherein said lockout member pendulum is a straight elongated member.

13. A gearshift interlock as described in claim 11 wherein said lockout member pendulum is a convex elongated member.

14. A gearshift interlock as described in claim 11 wherein said lockout member pendulum has an adjustable pivot point.

15. A gearshift interlock as described in claim 1 wherein said shift block detents are parallel facing.

16. A gearshift interlock as described in claim 1 wherein said shift block detents are outward facing.

17. A gearshift interlock as described in claim 1 wherein said shift block detents are cross facing.

18. A gearshift interlock as described claim 1 wherein at least one of said shift blocks is fluidly sealed in separate control volumes along said shift block's extreme ends.

19. A gearshift interlock as described in claim 1 wherein said shift blocks move in opposite directions from said neutral position to said actuated position.

20. A gearshift interlock as described in claim 1 wherein at least one of said shift blocks has said detent formed integral thereon.

21. A gearshift interlock comprising:
a first shift block operatively associated with a first synchronized gear, said first shift block being linearly hydraulically movable in a first direction between a neutral and actuated positions, said first shift block having a detent formed thereon;
a second shift block operatively associated with a second synchronized gear, said second shift block being linearly hydraulically movable in a direction opposite said first direction between neutral and actuated positions, said second shift block having a detent formed thereon, said second shift block been positioned adjacent said first shift block; and
a lockout member wherein movement of one of said shift blocks from said neutral position toward said actuated position causing said shift block to urge said lockout member to engage said other shift block detent to prevent movement of said other shift block.

22. A method of interlocking the operation of two synchronized gears on a common shaft of an automotive transmission comprising:
providing a first shift block operatively associated with said first synchronized gear hydraulically movable in a first direction between neutral and actuated positions, said first shift block having detent formed thereon;
providing a second shift block operatively associated with said second synchronized gear hydraulically movable in a direction opposite said first direction between neutral and actuated positions, said second shift block having a detent formed thereon, said second shift block been positioned adjacent said first shift block; and
moving of one of said shift blocks from said neutral position toward said actuated position causing said shift block to urge a lockout member to engage said other shift block detent to prevent movement of said other shift block.

23. A dual input transmission with a gearshift interlock, said gearshift interlock including:
a first shift block operatively associated with a first synchronized gear, said first shift block being movable between neutral and actuated positions, said first shift block having detent;
a second shift block operatively associated with a second synchronized gear, said second shift block being movable between neutral and actuated positions, said second shift block having a detent; and
a lockout member wherein movement of one of said shift blocks from said neutral position toward said actuated position cause said shift block to urge said lockout member to engage said other shift block detent to prevent movement of said other shift block.
